(19) United States
(12) Patent Application Publication
(10) Pub. No.: US 2009/0125136 A1
(43) Pub. Date: May 14, 2009

(54) Playback apparatus and playback method

(75) Inventor: Toshifumi Akiyama, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/289,618

(22) Filed: Oct. 30, 2008

(30) Foreign Application Priority Data
Nov. 2, 2007 (JP) 2007-286260

(51) Int. Cl. G06F 17/30; G06F 17/00; H04N 9/04; G06K 9/00; G06F 7/06

(52) U.S. Cl. 700/94; 707/4; 348/207.99; 382/181; 348/E09.002; 707/E17.022; 707/E17.014

(57) ABSTRACT

When a music file is played back as a piece of music, a CPU obtains date and time information associated with a music file to be played back, searches among image files memorized in a memory for an image file with which date and time information corresponding to the date and time information is associated, and causes a display unit to play back the searched image file while the music file is being played back. In addition, when an image file is played back as an image, the CPU searches among music files memorized in the memory for a music file with which date and time information corresponding to date and time information associated with an image Pile to be played back is associated, and causes a speaker to play back the searched music file while the image file is being played back.

### BACKGROUND OF THE INVENTION

1. Field of the Invention

The present invention relates to a playback apparatus and a playback method for playing back images, such as static images and moving images, and music.

2. Description of the Related Art

Conventionally, playback apparatuses for displaying images along with the playback of music have been known.

Japanese Patent Application Laid-Open No. 11-260045 has disclosed a constitution for searching the Internet to obtain information from the Web page of an artist of music to be played back, and display the information.

### SUMMARY OF THE INVENTION

However, in order to display an image along with playback of music, registered images have to be manually classified in advance. There is a problem that, if proper classification is not made, an image that does not match the music is played back.

Additionally, even if information is obtained from a Web page on the Internet, data files required for a search have to be prepared.

The present invention is made in the light of such situations, and has an object to provide a playback apparatus and a playback method capable of simultaneously playing back a piece of music and an image, which match each other, even if a user does not perform a classification operation in advance.

In order to achieve the above object, the present invention in a first aspect provides a playback apparatus comprising a music memory device, which memorizes a music file with which date and time information is associated, a music playback device, which plays back, as a piece of music, the music file memorized in the music memory device, an image memory device, which memorizes an image file with which date and time information is associated, an image playback device, which plays back, as an image, the image file memorized in the image memory device, a search device, which, when the music file is played back by the music playback device, obtains date and time information associated with the music file to be played back, and searches among image files memorized in the image memory device for an image file with which date and time information corresponding to the date and time information is associated, and a playback control device, which causes the image playback device to play back the image file searched for by the search device while the music file is being played back.

The present invention in a second aspect provides a playback apparatus comprising an image memory device, which memorizes an image file with which date and time information is associated, an image playback device, which plays back, as an image, the image file memorized in the image memory device, a music memory device, which memorizes a music file with which date and time information is associated, a music playback device, which plays back, as a piece of music, the music file memorized in the music memory device, a search device, which, when the image file is played back by the image playback device, searches among music files memorized in the music memory device for a music file with which date and time information corresponding to the date and time information associated with the image file to be played back is associated, and a playback control device, which causes the music playback device to play back the music file searched for by the search device while the image file is being played back.

Note that an “image” may be a moving image or a static image in the present invention.

In addition, in the present invention, “date and time information” is not particularly limited to a case including all of a year, month, date, hour and minute. For example, “date and time information” may be year, month and date information comprised of only a year, month and date, or may be include a second in addition to a year, month, date, hour and minute. Additionally, for example, the date and time information of a music file may be comprised of only a year, month and date, and the date and time information of an image file may include all of a year, month, date, hour and minute.

The present invention in a third aspect provides the playback apparatus according to the first or second aspect, wherein the search device determines whether or not the image file and the music file match in at least one among the era, year, month and date to perform a file search.

The present invention in a fourth aspect provides a playback apparatus comprising a photographing device, which takes a photograph, a photographing instruction input device into which a photographing instruction is entered, an image memory device, which memorizes an image file obtained by the photographing device, an image playback device, which plays back, as an image, the image file memorized in the image memory device, a music memory device, which memorizes a music file, a music playback device, which plays back, as a piece of music, the music file memorized in the music memory device, a file control device, which, when a photographing instruction is entered into the photographing instruction input device while a music file is being played back by the music playback device, associates an image file obtained by the photographing device with the music file being played back by the music playback device when the photograph was taken, and causes the image memory device to memorize the image file, and a playback control device, which, when the image file is played back by the image playback device, causes the music playback device to play back the music file associated with the image file while the image file is played back.

The present invention in a fifth aspect provides a playback apparatus comprising a photographing device, which takes a photograph, a photographing instruction input device into which a photographing instruction is entered, an image memory device, which memorizes an image file obtained by the photographing device, an image playback device, which plays back the image file memorized in the image memory device, a music memory device, which memorizes a music file, a music playback device, which plays back the music file memorized in the music memory device, a file control device, which, when a photographing instruction is entered into the photographing instruction input device while a music file is being played back by the music playback device, associates an image file obtained by the photographing device with the music file being played back by the music playback device when the photograph was taken, and causes the image memory device to memorize the image file, and a playback control device, which, when the music file is played back by the music playback device, causes the image playback device to play back the image file associated with the music file while the music file is played back.

The present invention in a sixth aspect provides the playback apparatus according to any one of the first to fifth aspects, further comprising: a reading device, which optically reads a photographic recording medium, such as a photographic print and a photographic film, a recognition device, which recognizes date and time information in a read image obtained by the reading device, and a file control device, which causes the image memory device to memorize, as the image file, the read image obtained by the reading device, and adds the date and time information recognized by the recognition device to the image file.

The present invention in a seventh aspect provides the playback apparatus according to any one of the first to fifth aspects further comprising: a recognition device, which recognizes date and time information in the image in the image file memorized in the image memory device, and a file control device, which determines whether or not date and time information exists in a header in the image file memorized in the image memory device, and, when no date and time information exists, adds the date and time information recognized by the recognition device to the header in the image file.

The present invention in an eighth aspect provides a playback method by which an image file is played back as an image, and a music file is played back as a piece of music, comprising the steps of: when a music file is played back, obtaining date and time information from a music file to be played back, searching among image files memorized in a predetermined memory device for an image file to which date and time information corresponding to the date and time information is added, preparing a list showing the searched image file, and continuously playing back the image file shown in the list while the music file is being played back.

The present invention in a ninth aspect provides a playback method by which an image file is played back as an image, and a music file is played back as a piece of music, comprising the steps of: when an image file is played back, obtaining date and time information from an image file to be played back, searching among music files memorized in a predetermined memory device for a music file to which date and time information corresponding to the date and time information is added, preparing a list showing the searched music file, and continuously playing back the music file shown in the list while the image file is being played back.

The present invention in a tenth aspect provides a playback method by which an image file is played back as an image, and a music file is played back as a piece of music, comprising the steps of: when a photographing instruction is entered into a predetermined photographing instruction input device while a music file is being played back, associating an image file obtained by taking a photograph with the music file being played back when the photograph was taken, and causing a predetermined memory device to memorize the image file, and then, when the image file is played back, playing back the music file associated with the image file while the image file is being played back.

The present invention in an eleventh aspect provides a playback method by which an image file is played back as an image, and a music file is played back as a piece of music, comprising the steps of: when a photographing instruction is entered into a predetermined photographing instruction input device while a music file is being played back, associating an image file obtained by taking a photograph with the music file being played back when the photograph was taken, and causing a predetermined memory device to memorize the image file, and then, when the music file is played back, playing back the image file associated with the music file while the music file is being played back.

The present invention in a twelfth aspect provides the playback method according to any one of the eighth to eleventh aspects, further comprising the steps of: optically reading a photographic recording medium, such as a photographic print and a photographic film, recognizing date and time information in a read image obtained, causing the memory device to memorize the read image as an image file, and adding the date and time information obtained from the read image to the image file.

The present invention in a thirteenth aspect provides the playback method according to any one of the eighth to eleventh aspects, further comprising the steps of: determining whether or not date and time information exists in a header in the image file to be played back, and, when no date and time information exists, recognizing date and time information in the image in the image file, and adding the date and time information to the header in the image file.

According to the present invention, even if a user does not perform a classification operation in advance, a piece of music and an image, which match each other, can be played back simultaneously.

### BRIEF DESCRIPTION OF THE DRAWINGS

FIG. 1 is a front view illustrating the appearance of an example of a playback apparatus;

FIG. 2 is the top view of FIG. 1;

FIG. 3 is a block diagram illustrating an example of a hardware configuration of the playback apparatus;

FIG. 4 is an explanatory view illustrating an example of a display screen while an image and a piece of music are being played back simultaneously;

FIG. 5 is an explanatory view illustrating an example of additional information added to a music file;

FIG. 6 is an explanatory view illustrating an example of additional information added to an image file;

FIG. 7 is a flowchart illustrating an example of a flow of image playback processing in a music playback mode;

FIG. 8 is an explanatory view of music continuous playback;

FIG. 9 is a flowchart illustrating an example of a flow of music playback processing in an image playback mode;

FIG. 10 is an explanatory view of image continuous playback;

FIG. 11 is a flowchart illustrating an example of a flow of association processing of an image file with a music file when a photograph is being taken;

FIG. 12 is an explanatory view partially illustrating an example of headers of music files with which image files are associated;

FIG. 13 is an explanatory view partially illustrating an example of headers of image files with which music files are associated;

FIG. 14 is a block diagram illustrating a hardware configuration of another exemplary playback apparatus;

FIG. 15 is an explanatory view used for an explanation of the reading of a photographic recording medium;

FIG. 16 is a flowchart illustrating an example of a flow of processing for recognizing shooting date information embedded in the photographic recording medium and adding it to an image file; and

FIG. 17 is a flowchart illustrating an example of a flow of processing for recognizing shooting date information embedded in an image of an image file and adding it to the image file.

### DETAILED DESCRIPTION OF THE PREFERRED EMBODIMENTS

An embodiment of the present invention will now be described in detail with reference to the drawings.

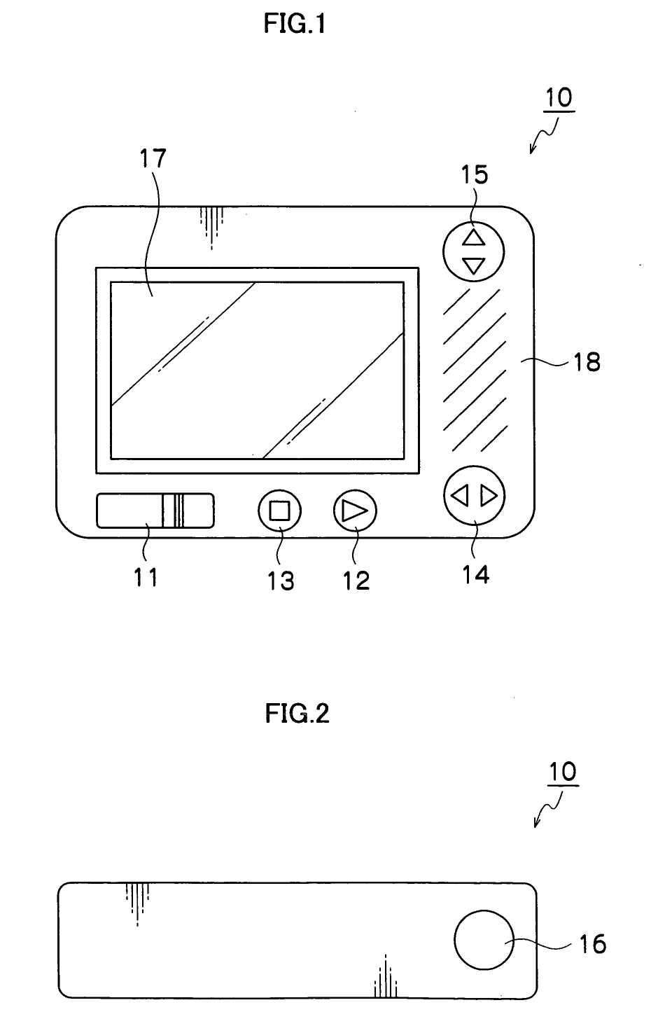

FIG. 1 is a front view illustrating the appearance of an example of a mobile playback apparatus, which plays back images (sometimes referred to as “video”) and pieces of music.

In FIG. 1, a playback apparatus 10 of the present example has a mode selector switch 11, a playback button 12, a stop button 13, a file select switch 14, a zoom switch 15, a display unit 17, a speaker 18 and the like.

The mode selector switch 11 is a switch by which an instruction for the selection of a mode, such as a photographing mode, a music playback mode and an image playback mode, is entered.

When a music playback mode is selected with the mode selector switch 11, every time the playback button 12 is pressed, a music file is played back as a piece of music. A user can listen to the music played back through the speaker 18. When the stop button 13 is pressed, the playback of the music stops. With the file select switch 14, a music file to be played back is selected.

When an image playback mode is selected with the mode selector switch 11, every time the playback button 12 is pressed, an image file is played back as an image. An image to be played back, which includes a static image and a moving image, is displayed on the display unit 17. A scaled-up image or a scaled-down image is shown by operating the zoom switch 15. When the stop button 13 is pressed, the playback of the image stops. With the file select switch 14, an image file to be played back is selected.

In FIG. 2, the top view of the playback apparatus 10 of FIG. 1 is shown. The playback apparatus 10 of the present example has a digital camera function, and, if a photographing mode has been selected with the mode selector switch 11 of FIG. 1, pressing a shutter button 16 takes a photograph.

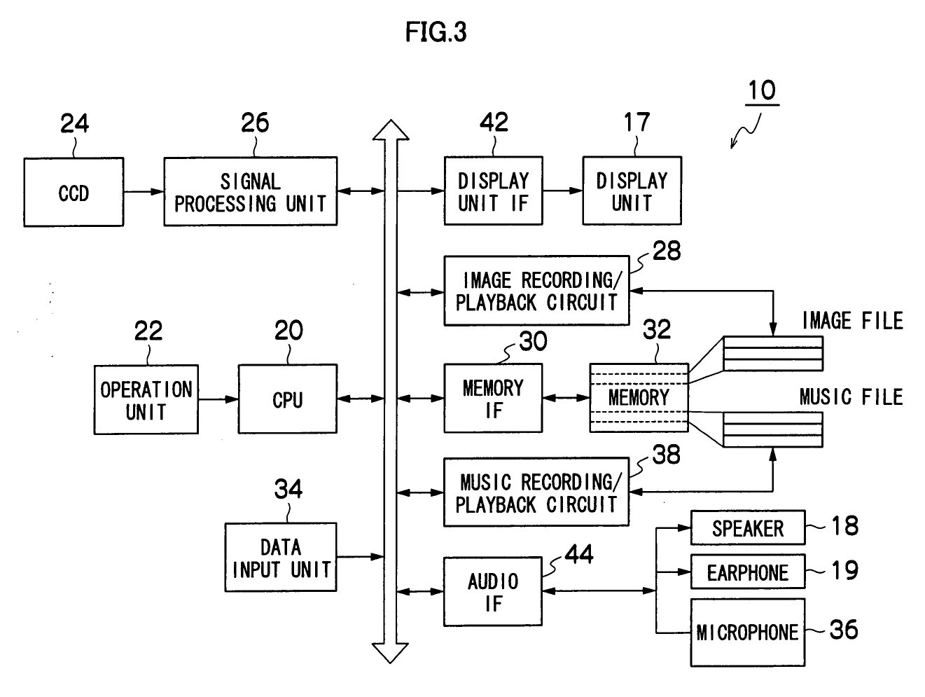

FIG. 3 is a block diagram illustrating an example of a hardware configuration of the playback apparatus 10.

In FIG. 3, a central processing unit (CPU) 20 integrally controls each portion of the playback apparatus 10 according to instructions entered through an operation unit 22.

The operation unit 22 is comprised of various types of switches 11, 14 and 15, and buttons 12, 13 and 16 shown in FIGS. 1 and 2.

When the shutter button 16 of FIG. 2 is pressed, a charge coupled device (CCD) 24 picks up and generates the image of an object, such as a static image and a moving image. The image generated by the CCD 24 is subjected to predetermined signal processing at a signal processing unit 26, converted into a format for recording by an image recording/playback circuit 28, and written into a memory 32 through a memory interface 30 as an image file. To the image file, date and time information (e.g., year, month, date, hour and minute), which represents the shooting date and time, is added by the CPU 20. That is to say, an image obtained by taking a photograph of a desired object according to the photographing instruction by a user is memorized in the memory 32 as an image file to which date and time information is added.

A data input unit 34 is a port into which image files and music files are entered from the outside of the playback apparatus 10. The image file entered into the data input unit 34 is converted into a format for recording by the image recording/playback circuit 28, as necessary, and written into the memory 32 through the memory interface 30. Additionally, the music file entered into the data input unit 34 is converted into a format for recording by a music recording/playback circuit 38, as necessary, and written into the memory 32 through the memory interface 30.

In addition, audio entered into a microphone 36 is converted into a format for recording by the music recording/playback circuit 38, and written into the memory 32 through the memory interface 30. Such a file generated by audio input through the microphone 36 is also included in a “music file” in this specification. In this case, to the music file, date and time information (e.g., year, month, date, hour and minute), which represents the recording date and time (creation date and time), is added by the CPU 20.

Generally, date and time information is added to music files and image files. Date and time information for music files includes the creation date of the music and the sale date of the music, for example. Date and time information for image files includes shooting date and time information.

Note that “date and time information” is not particularly limited to a case including all of a year, month, date, hour and minute. For example, “date and time information” may be year, month and date information comprised of only a year, month and date, or may be include a second in addition to a year, month, date, hour and minute. Additionally, for example, the date and time information of a music file may be comprised of only a year, month and date, and the date and time information of an image file may include all of a year, month, date, hour and minute.

When an image is played back, an image file memorized in the memory 32 is read through the memory interface 30, converted into a format for playback by the image recording/playback circuit 28, and outputted to the display unit 17 through a display unit interface 42. Such playback of an image is sometimes referred to as playback of “an image file”.

When a piece of music is played back, a music file memorized in the memory 32 is read through the memory interface 30, converted into a format for playback by the music recording/playback circuit 38, and outputted to the speaker 18 or an earphone 19 of FIG. 1 through an audio interface 44. Such playback of music is sometimes referred to as playback of “a music file”.

The CPU 20 of the present embodiment performs file control to associate an image file with a music file, a search for an image file and a music file, and playback control to simultaneously play back the image file and the music file.

When the music recording/playback circuit 38 and the speaker 18 (or earphone 19) play back a music file selected by the file select switch 14, the CPU 20 obtains date and time information added to the music file to be played back, and searches among image files memorized in the memory 32 for an image file to which date and time information at least partially matching the date and time information is added. Then, the CPU prepares a list showing the searched image file, and uses the image recording/playback circuit 28 and the display unit 17 to continuously play back the image file shown in the list while the music file is being played back.

Additionally, when the image recording/playback circuit 28 and the display unit 17 play back an image file selected by the file select switch 14, the CPU 20 obtains date and time information added to the image file to be played back, and searches among music files memorized in the memory 32 for a music file to which date and time information at least partially matching the year, date and time information is added. Then, the CPU prepares a list showing the searched music file, and uses the music recording/playback circuit 38 and the speaker 18 (or earphone 19) to continuously play back the music file shown in the list while the image file is being played back.

Here, the date and time information “at least partially matches” may, even if it is not a case in which the date and time information of the image file and that of the music file all match (total match), be a case in which the date and time information of both partially match (partial match). For example, it may be a matching era (e.g., 2010s), a matching year, matching year and month, a matching month, matching year, month and date, matching month and date, or a matching season (e.g., spring, summer, autumn or winter).

For example, in case of a matching era, in the music playback mode, an image matching the era of the music to be played back is played back simultaneously, and in the image playback mode, music matching the era of the image to be played back is played back.

The correspondence between the components of the playback apparatus 10 of the example shown in FIGS. 1, 2 and 3 and the components of the present invention will be briefly described. A music memory device and an image memory device in the present invention are mainly constituted by the memory 32 of FIG. 3. An image playback device in the present invention is mainly constituted by the image recording/playback circuit 28 and the display unit 17 of FIG. 3. A music playback device in the present invention is mainly constituted by the music recording/playback circuit 38, the speaker 18 and the earphone 19 of FIG. 3. A search device, a playback control device and a file control device in the present invention are mainly constituted by the CPU 20 of FIG. 3. A photographing device in the present invention is mainly constituted by the CCD 24, the signal processing unit 26 and the image recording/playback circuit 28 of FIG. 3. A photographing instruction input device in the present invention is mainly constituted by the shutter button 16 of FIG. 2.

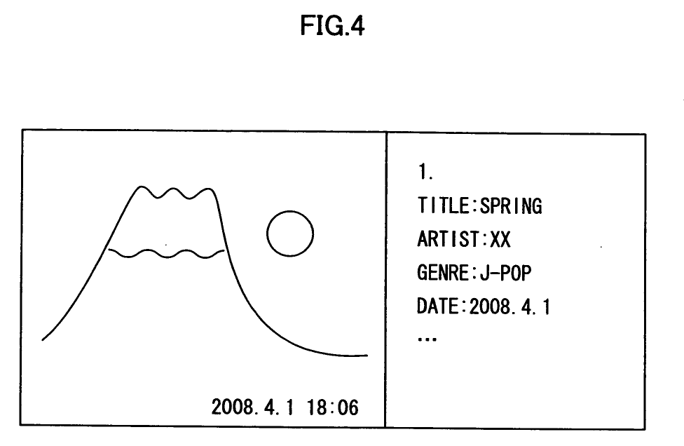

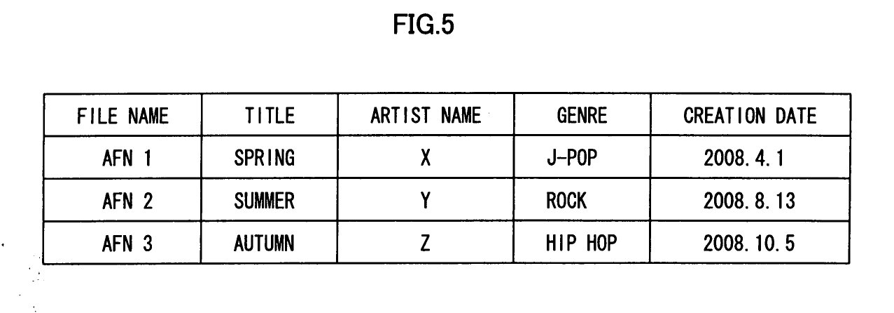

FIG. 4 shows an example of a display screen while an image and a piece of music are being played back simultaneously.

In FIG. 4, on the left of the screen, an image, which is being played back, and the date and time when the image was recorded (shooting date and time) are displayed. On the right of the screen, various types of information (e.g., title, artist name, genre, and creation date) on music, which is being played back, are displayed.

FIG. 5 is an explanatory view used for an explanation of additional information added to a music file. In the example shown in FIG. 5, additional information such as a file name, a title, an artist name, a genre, and a creation date of the music (year, month, and date) is written into the header of each music file.

Note that although a case where the creation date of a piece of music is added to a music file will be described as an example, date and time information added to a music file is not particularly limited to a creation date in the present invention, and the sale date (sale date of a compact disk: CD) or release date of the music may be possible.

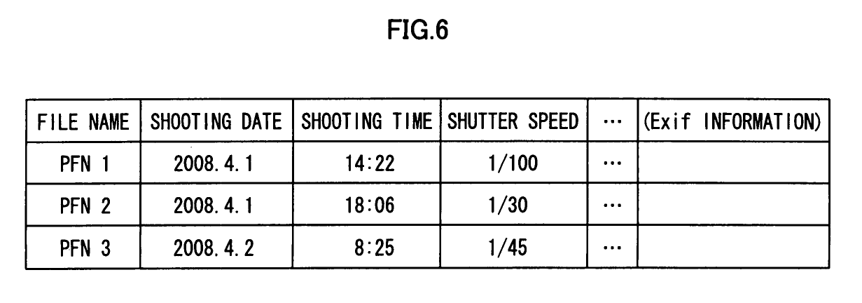

FIG. 6 is an explanatory view used for an explanation of additional information added to an image file. In the example shown in FIG. 6, additional information, such as a file name, a shooting date (year, month and date), a shooting time (hour and minute), and shutter speed, is written in the header of each image file. The additional information is, for example, exchangeable image file format (Exif) information.

Note that although a case where the shooting date and time (creation date and time of an image) is added to an image file will be described as an example, date and time information added to an image file is not particularly limited to a shooting date and time in the present invention, and the sale date or release date of the image may be possible.

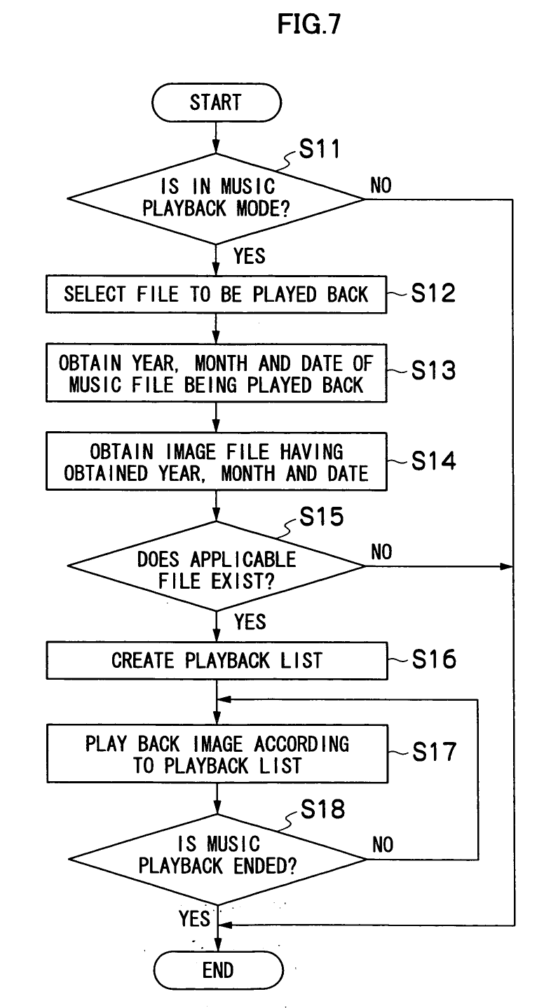

FIG. 7 is a flowchart illustrating an example of a flow of image playback processing in a music playback mode. The processing is performed by the integral control of the CPU 20 of FIG. 3.

In the present example, it is assumed that year, month and date information comprised of a year, month and date is added to a music file as date and time information, and shooting date and time information including a year, month, date, hour and minute is added to an image file as date and time information.

First, in step S11, whether or not a music playback mode has been selected by the mode selector switch 11 is determined.

When the music playback mode has been selected, in step S12, the selection of a music file by the file select button 14 is accepted. For example, a list of music files is displayed on the display unit 17, and a user uses the file select button 14 to select a desired music file.

Next, in step S13, year, month and date information is obtained from the selected music file. For example, as shown in FIG. 5, when a “creation date” is added to the music file, the “creation date” is obtained.

Next, in step S14, based on the year, month and date information obtained from the music file, an image file to which shooting date and time information at least partially matching the year, month and date information of the music file is added is searched for among image files memorized in the memory 32. For example, as shown in FIG. 6, when a “shooting date” is added to the image file, an image file whose “shooting date” partially matches the “creation date” of the music file is searched for.

For example, if a music file was created on April 2008, an image file photographed and recorded in the memory 32 on April 2008 is searched for.

In step S15, whether or not an image file meeting the search condition exists is determined, and if an applicable image file exists, a list showing the applicable image file (playback image list) is prepared in step S16, and the image file listed on the playback image list is displayed (played back) continuously on the display unit 17 in step S17.

The image file is played back along with the playback of the music file. If the playback time of one music file is longer than that of one image file (e.g., one static image), image files are played back at regular time intervals, in order of the shooting date and time, or randomly while the music file is being played back.

In step S18, whether or not the playback ends is determined. The end of the playback of one music file may be “the end of the playback of music”, or a plurality of music files may be played back continuously. In this case, as a continuous music playback mode, a playback music list is prepared, and a plurality of music files are played back continuously.

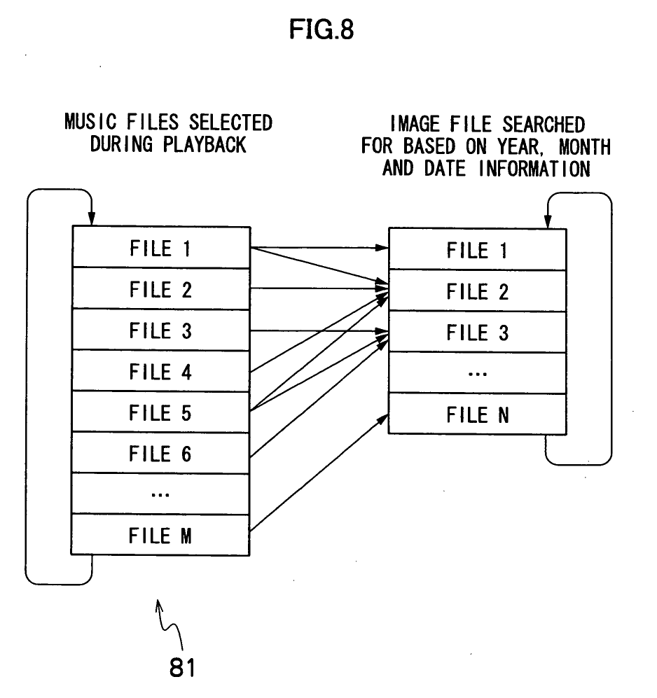

FIG. 8 schematically shows the continuous music playback when a plurality (m) of music files are selected. In FIG. 8, a playback music list 81 is a list of music files selected by the file select button 14. The m music files in the playback music list 81 are repeatedly and continuously played back until the stop button 13 is pressed down. While each music file is being played back, an image file searched for based on the year, month and date information of the music file is played back. While one music file is being played back, an image file matching the year, month and date information of the music file is repeatedly and continuously played back.

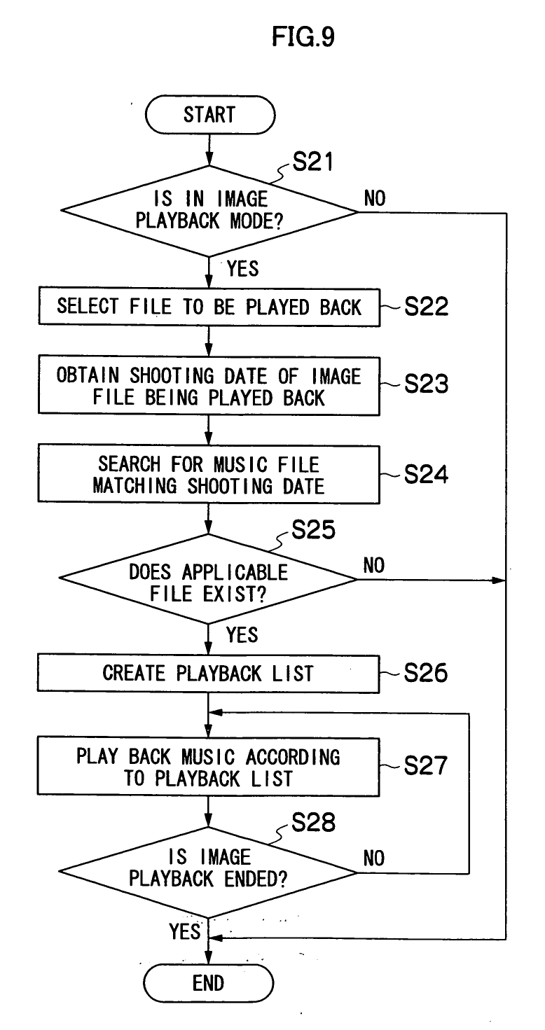

FIG. 9 is a flowchart illustrating an example of a flow of music playback processing in an image playback mode. The processing is performed by the integral control of the CPU 20 of FIG. 3.

In the present example, it is assumed that year, month and date information comprised of a year, month and date is added to a music file as date and time information, and shooting date and time information including a year, month, date, hour and minute is added to an image file as date and time information.

First, in step S21, whether or not an image playback mode has been selected by the mode selector switch 11 is determined.

When the image playback mode has been selected, in step S22, the selection of an image file by the file select button 14 is accepted. For example, a list of image files is displayed on the display unit 17, and a user uses the file select button 14 to select a desired image file.

Next, in step S23, shooting date and time information is obtained from the selected image file. For example, as shown in FIG. 6, “shooting date” (year. month. date), and “shooting time” (hour: minute) are added to the image file.

Next, in step S24, based on the shooting date and time information obtained from the image file, a music file to which year, month and date information at least partially matching the shooting date and time information of the image file is added is searched for among music files memorized in the memory 32. For example, as shown in FIG. 5, when a “creation date” is added to the music file, a music file whose “creation date” partially matches the “shooting date” of the image file is searched for.

For example, if an image file was photographed and memorized in the memory 32 on April 2008, a music file created on April 2008 is searched for.

In step S25, whether or not a music file meeting the search condition exists is determined, and if an applicable music file exists, a list showing the applicable music file (playback music list) is prepared in step S26, and the music file listed on the playback music list is outputted (played back) continuously from the speaker 18 (or earphone 19) in step S27.

The music file is played back along with the playback of the image file. If the playback time of one image file (e.g., one moving image) is longer than that of one music file, music files are played back at regular time intervals, in order of the creation date, or randomly while the image file is being played back.

In step S28, whether or not the playback ends is determined. The end of the playback of one image file may be “the end of the playback of image”, or a plurality of image files (e.g., static files) may be played back continuously. In this case, as a continuous image playback mode, a playback image list is prepared, and a plurality of image files are played back continuously.

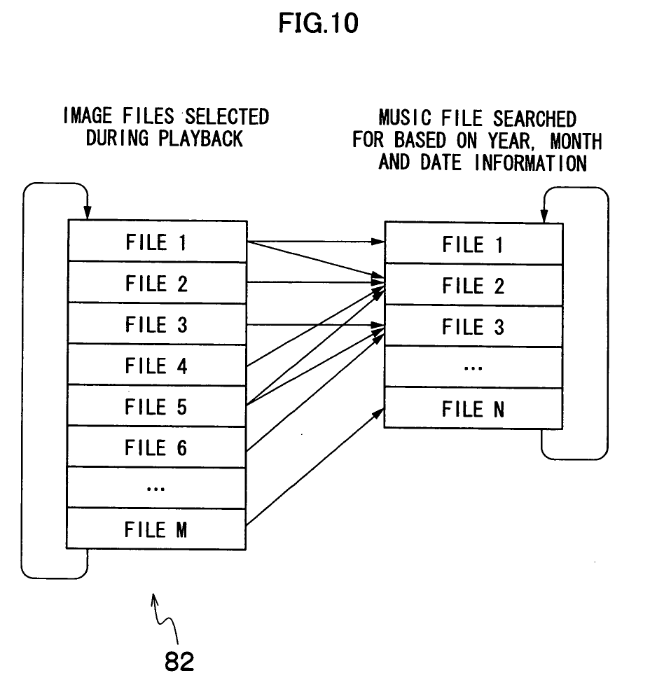

FIG. 10 schematically shows the continuous image playback when a plurality

(m) of image files are selected. In FIG. 10, a playback image list 82 is a list of image files selected by the file select button 14. The m image files in the playback image list 82 are repeatedly and continuously played back until the stop button 13 is pressed down. While each image file is being played back, a music file searched for based on the shooting date and time information (“shooting date” in the present example) of the image file is played back. While one image file is being played back, a music file matching the shooting date and time information of the image file is repeatedly and continuously played back.

Although a case where date and time information has already been added to both of an image file and a music file memorized in the memory 32 has been described above, the present invention is not practically limited to such a case.

Next, a case where the CPU 20 associates an image file with a music file when a photograph is being taken will be described by way of example. In this example, the CPU 20 of FIG. 3 associates an image file obtained by taking a photograph with a music file played back when the photograph was taken (actually a music file memorized in the memory 32) and memorizes the image file in the memory 32, when a photographing instruction is entered by pressing down the shutter button 16 while the music file is being played back by the music recording/playback circuit 38 and the speaker 18 (or earphone 19).

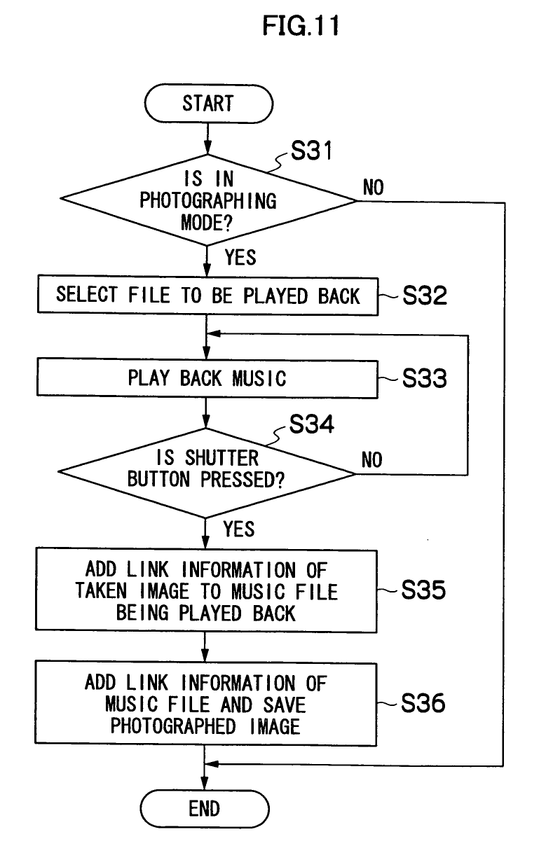

FIG. 11 is a flowchart illustrating an example of a flow of association processing of an image file with a music file when a photograph is being taken. The processing is performed by the integral control of the CPU 20 of FIG. 3.

In step S31, whether or not a photographing mode has been selected by the mode selector switch 11 is determined.

When the photographing mode has been selected, in step S32, the selection of a music file by the file select button 14 is accepted, and the music is played back in step S33.

In step S34, whether or not the shutter button 16 is pressed down while the music is being played back is determined.

The music is continued to be played back until the shutter button 16 is pressed down. In this manner, in the present example, in the photographing mode, a user uses the file select button 14 to indicate a desired music file, and waits for a photo opportunity while enjoying listening to the music, which is being played back.

When the shutter button 16 is pressed down while the music is being played back, in step S35, link information for the image file obtained by taking a photograph is added to the music file (actually a music file memorized in the memory 32), which is being played back, meanwhile, in step S36, link information for the music file, which is being played back, is added to the image file obtained by taking a photograph, and the image file is saved in the memory 32.

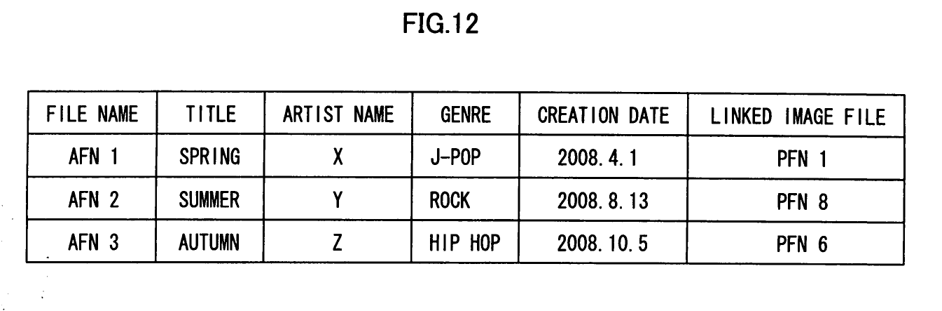

FIG. 12 shows by a list an example of headers of music files with which image files are associated. In FIG. 12, file names of linked image files (PFN1, PFN2, PFN3, . . . ) are added to the header of each music file (file name: AFN1, AFN2, AFN3, . . . ). That is to say, a file name is added to each music file as the link information for an image file.

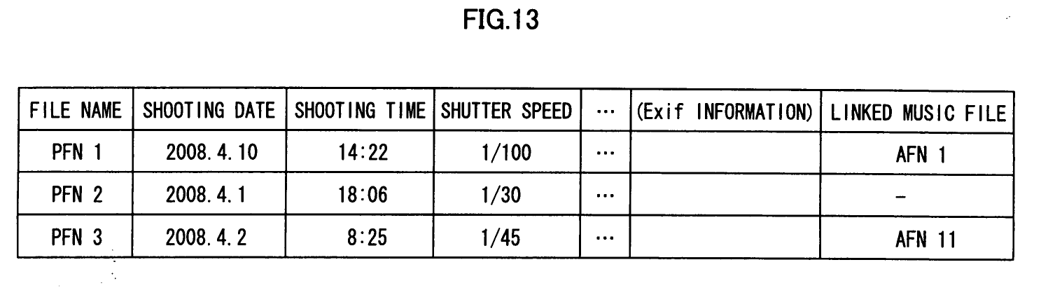

FIG. 13 shows by a list an example of headers of image files with which music files are associated. In FIG. 13, file names of linked music files (AFN1, AFN2, AFN3, . . . ) are added to the header of each image file (file name: PFN1, PFN2, PFN3, . . . ). That is to say, a file name as the link information for a music file is added to each image file.

As described above, in the present example, when a photographing instruction is entered by the shutter button 16 while a music file is being played back, the CPU 20 associates an image file obtained by taking a photograph with the music file being played back when the photograph was being taken, and saves the image file in the memory 32.

Thereafter, when the music is played back, as in a case described with reference to FIG. 7, the image file associated with the music file is obtained from the memory 32, and played back simultaneously with the playback of the music. In the present example, the CPU 20 controls the acquisition of an image file name as link information for the image file from the header of the music file, and the reading and playback of the music file from the memory 32 based on the link information.

Additionally, when the image is played back, as in a case described with reference to FIG. 9, the music file associated with the image file is obtained from the memory 32, and played back simultaneously with the playback of the image. In the present example, the CPU 20 controls the acquisition of an image file name as link information for the image file from the header of the image file, and the reading and playback of the image file from the memory 32 based on the link information.

Note that although, in FIGS. 12 and 13, a file name is used as link information, the present invention is not particularly limited to such a case. Link information may include the storage location or the method of acquisition of the file. For example, when a plurality of directories are created in the memory 32, and files are distributed over and stored in different directories, directory information is included in the link information. In addition, when files are saved outside the playback apparatus 10, the method of acquisition from the outside is included.

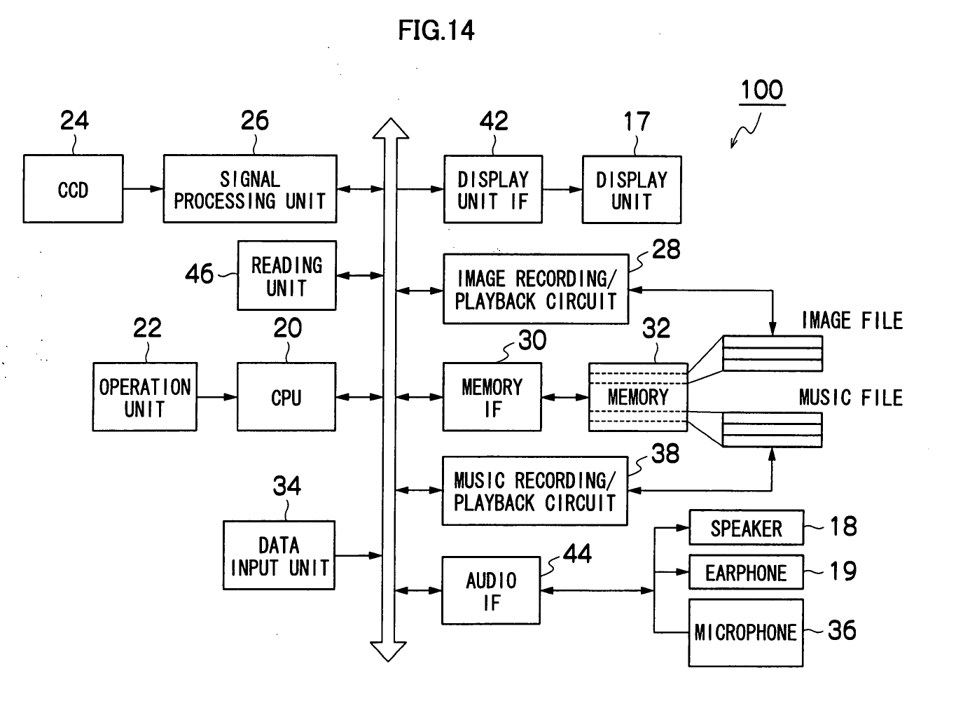

FIG. 14 is a block diagram illustrating a hardware configuration of another exemplary playback apparatus 100. In FIG. 14, the same reference numerals are used to designate the same components as those of the playback apparatus 10 shown in FIG. 3, and the description of the components already explained will be omitted.

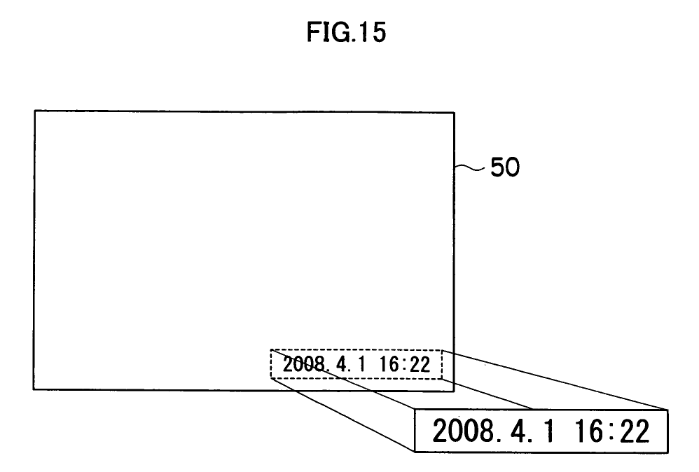

The playback apparatus 100 of the present example has a reading unit 46, which optically reads a photographic recording medium 50, as shown in FIG. 15.

In FIG. 15, a photographic print comprising an image printed on a sheet is taken as an example of a photographic recording medium (medium comprising a photograph recorded in a visible state); however a photographic recording medium is not particularly limited thereto, and may be, for example, a photographic film comprising an image formed on a film made of resin.

When the photographic recording medium 50 is optically read by the reading unit 46, the CPU 20 recognizes shooting date and time information, that is to say, “year. month. date” (shooting date) and “hour:minute” (shooting time), in the read image obtained by the reading unit 46. Then, the CPU 20 adds the shooting date and time information to the image file when causing the memory 32 to memorize the read image as an image file.

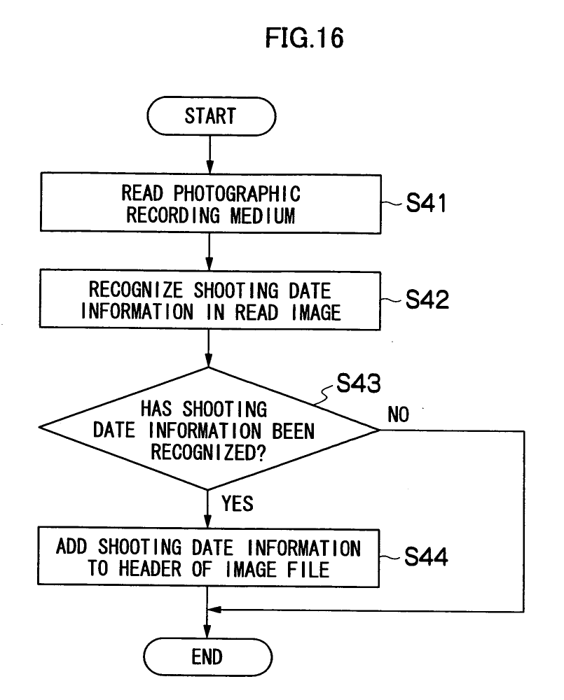

FIG. 16 is a flowchart illustrating an example of a flow of processing for recognizing shooting date and time information embedded in the photographic recording medium 50 and adding it to an image file.

First, in step S41, the photographic recording medium 50 is optically read by the reading unit 46, and the read image outputted from the reading unit 46 is memorized in the memory 32 as an image file.

Next, in step S42, the shooting date and time information in the read image is recognized. More specifically, the portion of a numeral image is extracted from the read image, and based on the numeral image, shooting date and time information is obtained by character recognition. In other words, as shown in FIG. 15, the shooting date and time embedded in the photographic recording medium 50 is scanned.

In step S43, whether or not shooting date and time information could be recognized is determined, and when shooting date and time information could be recognized, the shooting date and time information is added to the header of the image file in step S44.

In addition, the CPU 20 of the present example determines whether or not shooting date and time information exists in the header of the image file memorized in the memory 32, and, when no shooting date and time information exists, recognizes shooting date and time information, that is to say, “year. month. date” (shooting date) and “hour:minute” (photographing time) in the image in the image file. Then, the CPU 20 adds the recognized shooting date and time information to the header in the image file.

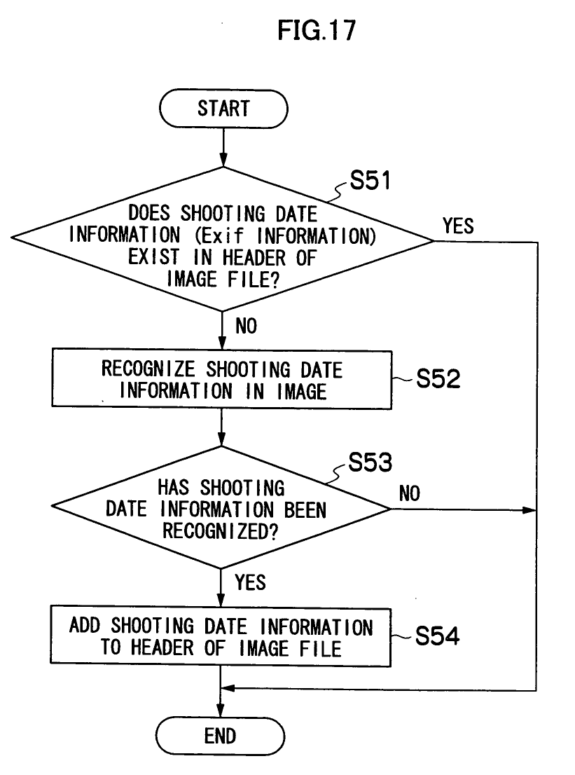

FIG. 17 is a flowchart illustrating an example of a flow of processing for recognizing shooting date and time information embedded in an image of an image file and adding it to the image file.

In the present example, the image file is in an exchangeable image file format (Exif).

First, in step S51, whether or not shooting date and time information in a text format exists as additional information (Exif information) in the header (Exif header) of an image file memorized in the memory 32 is determined.

When no shooting date and time information exists in the head of the image header, the shooting date and time information in the image of the image file is recognized in step S52. More specifically, the portion of a numeral image is extracted from the image file, and based on the numeral image, shooting date and time information is obtained by character recognition.

In step S53, whether or not shooting date and time information could be recognized is determined, and when shooting date and time information could be recognized, the shooting date and time information is added to the header of the image file in step S54.

Thereafter, when the music is played back, as described with reference to FIG. 7, based on year, month and date information added to the music file, and shooting date and time information added to the image file, an image file corresponding to the music file, which is being played back, is searched for and played back.

In addition, when the image is played back, as described with reference to FIG. 9, based on year, month and date information added to the music file, and shooting date and time information added to the image file, a music file corresponding to the image file, which is being played back, is searched for and played back.

In the embodiment described with reference to FIGS. 1 to 17, the correspondence condition between a image file and a music file that are to be played back simultaneously, includes a matching era, a matching year, a matching month, matching year and month, matching month and date and a matching season. A user can use the operation unit 22 to set and operate these correspondence conditions. More specifically, under the CPU 20 control, a list of the correspondence conditions is displayed on the display unit 17, and the user enters an instruction for the correspondence conditions using the buttons on the operation unit 22. The entered correspondence condition is memorized in the memory 32 under the CPU 20 control, and, when a music file is played back, and an image file is played back, the condition is read from the memory 32, then an image file or a music file is searched for according to the read correspondence condition.

For example, when a user enters an instruction for “a matching era” as a correspondence condition, while the music file is being played back, an image file to which date and time information (e.g., shooting date) matching date and time information (e.g., sale date) and the era added to the music file is added, is searched for and played back. In addition, while an image file is being played back, a music file to which date and time information (e.g., sale date) matching date and time information (e.g., shooting date) and the era added to the image file is added, is searched for and played back.

Additionally, when the user enters an instruction for “matching year, month and date” as a correspondence condition, an image file and a music file matching each other in a year, month and date are played back simultaneously. Of course, the user can input an instruction for other correspondence conditions (e.g., a matching season). Further, entering instructions for letting the CPU 20 select the correspondence conditions is also possible.

Note that the present invention is not limited to examples described in the present specification and shown in the drawings, and of course, various types of design change and improvement can be made without departing from the sprit of the present invention.

What is claimed is:

1. A playback apparatus comprising:
a music memory device, which memorizes a music file with which date and time information is associated;
a music playback device, which plays back, as a piece of music, the music file memorized in the music memory device;
an image memory device, which memorizes an image file with which date and time information is associated;
an image playback device, which plays back, as an image, the image file memorized in the image memory device;
a search device, which, when the music file is played back by the music playback device, obtains date and time information associated with the music file to be played back, and searches among image files memorized in the image memory device for an image file with which date and time information corresponding to the obtained date and time information is associated; and
a playback control device, which causes the image playback device to play back the image file searched for by the search device while the music file is being played back.

2. The playback apparatus according to claim 1, wherein the search device determines whether or not the image file and the music file match in at least one among the era, year, month and date to perform a file search.

3. The playback apparatus according to claim 1, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

4. The playback apparatus according to claim 2, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

5. The playback apparatus according to claim 1, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

6. The playback apparatus according to claim 2, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

7. A playback apparatus comprising:
an image memory device, which memorizes an image file with which date and time information is associated;
an image playback device, which plays back, as an image, the image file memorized in the image memory device;
a music memory device, which memorizes a music file with which date and time information is associated;
a music playback device, which plays back, as a piece of music, the music file memorized in the music memory device;
a search device, which, when the image file is played back by the image playback device, searches among music files memorized in the music memory device for a music file with which date and time information corresponding to the date and time information associated with the image file to be played back is associated; and
a playback control device, which causes the music playback device to play back the music file searched for by the search device while the image file is being played back.

8. The playback apparatus according to claim 7, wherein the search device determines whether or not the image file and the music file match in at least one among the era, year, month and date to perform a file search.

9. The playback apparatus according to claim 7, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

10. The playback apparatus according to claim 8, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

11. The playback apparatus according to claim 7, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

12. The playback apparatus according to claim 8, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

13. A playback apparatus comprising:
a photographing device, which takes a photograph;
a photographing instruction input device into which a photographing instruction is entered;
an image memory device, which memorizes an image file obtained by the photographing device;
an image playback device, which plays back, as an image, the image file memorized in the image memory device;
a music memory device, which memorize a music file;
a music playback device, which plays back, as a piece of music, the music file memorized in the music memory device;
a file control device, which, when a photographing instruction is entered into the photographing instruction input device while a music file is being played back by the music playback device, associates an image file obtained by the photographing device with the music file being played back by the music playback device when the photograph was taken, and causes the image memory device to memorize the image file; and
a playback control device, which, when the image file is played back by the image playback device, causes the music playback device to play back the music file associated with the image file while the image file is played back.

14. The playback apparatus according to claim 13, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

15. The playback apparatus according to claim 13, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

16. A playback apparatus comprising:
a photographing device, which takes a photograph;
a photographing instruction input device into which a photographing instruction is entered;
an image memory device, which memorizes an image file obtained by the photographing device;
an image playback device, which plays back the image file memorized in the image memory device;
a music memory device, which memorize a music file;
a music playback device, which plays back the music file memorized in the music memory device;
a file control device, which, when a photographing instruction is entered into the photographing instruction input device while a music file is being played back by the music playback device, associates an image file obtained by the photographing device with the music file being played back by the music playback device when the photograph was taken, and causes the image memory device to memorize the image file; and
a playback control device, which, when the music file is played back by the music playback device, causes the image playback device to play back the image file associated with the music file while the music file is played back.

17. The playback apparatus according to claim 16, further comprising:
a reading device, which optically reads a photographic recording medium, such as a photographic print and a photographic film;
a recognition device, which recognizes date and time information in a read image obtained by the reading device; and
a file control device, which causes the image memory device to memorize, as the image file, the read image obtained by the reading device, and adds the date and time information recognized by the recognition device to the image file.

18. The playback apparatus according to claim 16, further comprising:
a recognition device, which recognizes date and time information in the image in the image file memorized in the image memory device; and
a file control device, which determines whether or not date and time information exists in a header in the image file memorized in the image memory device, and, when no date and time information exists, adds the date and time information recognized by the recognition device to the header in the image file.

19. A playback method by which an image file is played back as an image, and a music file is played back as a piece of music, comprising the steps of:
when a music file is played back, obtaining date and time information from a music file to be played back;
searching among image files memorized in a predetermined memory device for an image file to which date and time information corresponding to the date and time information is added;
preparing a list showing the searched image file; and
continuously playing back the image file shown in the list while the music file is being played back.

20. The playback method according to claim 19, further comprising the steps of:
optically reading a photographic recording medium, such as a photographic print and a photographic film;
recognizing date and time information in a read image obtained;
causing the memory device to memorize the read image as an image file; and
adding the date and time information obtained from the read image to the image file.

21. The playback method according to claim 19, further comprising the steps of:
determining whether or not date and time information exists in a header in the image file to be played back; and
when no date and time information exists, recognizing date and time information in the image in the image file, and adding the date and time information to the header in the image file.

22. A playback method by which an image file is played back as an image, and a music file is played back as a piece of music, comprising the steps of:
when an image file is played back, obtaining date and time information from an image file to be played back;
searching among music files memorized in a predetermined memory device for a music file to which date and time information corresponding to the date and time information is added;
preparing a list showing the searched music file; and
continuously playing back the music file shown in the list while the image file is being played back.

23. The playback method according to claim 22, further comprising the steps of:
optically reading a photographic recording medium, such as a photographic print and a photographic film;
recognizing date and time information in a read image obtained;
causing the memory device to memorize the read image as an image file; and
adding the date and time information obtained from the read image to the image file.

24. The playback method according to claim 22, further comprising the steps of:
determining whether or not date and time information exists in a header in the image file to be played back; and
when no date and time information exists, recognizing date and time information in the image in the image file, and adding the date and time information to the header in the image file.

25. A playback method by which an image file is played back as an image, and a music file is played back as a piece of music, comprising the steps of:
when a photographing instruction is entered into a predetermined photographing instruction input device while a music file is being played back, associating an image file obtained by taking a photograph with the music file being played back when the photograph was taken, and causing a predetermined memory device to memorize the image file; and then,
when the image file is played back, playing back the music file associated with the image file while the image file is being played back.

26. The playback method according to claim 25, further comprising the steps of:
optically reading a photographic recording medium, such as a photographic print and a photographic film;
recognizing date and time information in a read image obtained;
causing the memory device to memorize the read image as an image file; and
adding the date and time information obtained from the read image to the image file.

27. The playback method according to claim 25, further comprising the steps of:
determining whether or not date and time information exists in a header in the image file to be played back; and
when no date and time information exists, recognizing date and time information in the image in the image file, and adding the date and time information to the header in the image file.

28. A playback method by which an image file is played back as an image, and a music file is played back as a piece of music, comprising the steps of:
when a photographing instruction is entered into a predetermined photographing instruction input device while a music file is being played back, associating an image file obtained by taking a photograph with the music file being played back when the photograph was taken, and causing a predetermined memory device to memorize the image file; and then,
when the music file is played back, playing back the image file associated with the music file while the music file is being played back.

29. The playback method according to claim 28, further comprising the steps of:
optically reading a photographic recording medium, such as a photographic print and a photographic film;
recognizing date and time information in a read image obtained;
causing the memory device to memorize the read image as an image file; and
adding the date and time information obtained from the read image to the image file.

30. The playback method according to claim 28, further comprising the steps of:
determining whether or not date and time information exists in a header in the image file to be played back; and
when no date and time information exists, recognizing date and time information in the image in the image file, and adding the date and time information to the header in the image file.
